(19) United States
(12) Patent Application Publication
(10) Pub. No.: US 2016/0214383 A1
(43) Pub. Date: Jul. 28, 2016

(54) HEAD UNIT AND RECORDING APPARATUS

(71) Applicant: SEIKO EPSON CORPORATION, Tokyo (JP)

(72) Inventor: Takahiro KOBAYASHI, Matsumoto-shi (JP)

(21) Appl. No.: 14/995,701

(22) Filed: Jan. 14, 2016

(30) Foreign Application Priority Data
Jan. 26, 2015 (JP) 2015-012329

(51) Int. Cl. B41J 2/14

(52) U.S. Cl. CPC B41J 2/1433

(57) ABSTRACT

A head unit includes: a recording head which can discharge liquid from nozzles; a plate portion to which the recording head is attached in a state where a nozzle forming surface on which the nozzles are formed protrudes; and a protection portion which protects the nozzle forming surface, in which the protection portion is attached to the plate portion in a state where a space is provided between the protection portion and the plate portion when viewed from an intersecting direction which intersects with a protruding direction of the nozzle forming surface, and in which the nozzle forming surface is positioned within a range of a thickness in the protruding direction of the protection portion when viewed from the intersecting direction.

### BACKGROUND

1. Technical Field

The present invention relates to a head unit and a recording apparatus.

2. Related Art

In the related art, a recording apparatus which is provided with a recording head that performs recording by discharging liquid, such as ink, to a recording medium is used. In such a recording apparatus, there is a case where mist which is generated as the liquid is discharged from the recording head becomes adhered to a head unit. Here, a recording apparatus aiming at preventing the mist from becoming adhered is disclosed.

For example, in JP-A-2008-93849, a recording apparatus which is provided with an ink mist capturing member having an ink passing port in a carriage, and of which an object is preventing the mist from becoming adhered by an airflow as the carriage that functions as a head unit moves, is disclosed.

However, it is assumed that the recording apparatus of JP-A-2008-93849 captures all of the generated mist by the ink mist capturing member before the mist passes through the ink passing port. However, there is a case where it is difficult to capture all of the mist by the ink mist capturing member before the mist passes through the ink passing port according to the size or the like of a liquid droplet discharged from the recording head. In addition, in this case, there is a case where the mist which passes through the ink passing port becomes adhered to the head unit.

### SUMMARY

An advantage of some aspects of the invention is to prevent mist which is generated as liquid is discharged from a recording head from becoming adhered to a head unit.

According to an aspect of the invention, there is provided a head unit including: a recording head which discharges liquid from nozzles; a plate portion to which the recording head is attached in a state where a nozzle forming surface on which the nozzles are formed protrudes; and a protection portion which protects the nozzle forming surface, in which the protection portion is attached to the plate portion in a state where a space is provided between the protection portion and the plate portion when viewed from an intersecting direction which intersects with a protruding direction of the nozzle forming surface, and in which the nozzle forming surface is positioned within a range of a thickness in the protruding direction of the protection portion when viewed from the intersecting direction.

In the head unit, the nozzle forming surface may be positioned in a state of being recessed with respect to a protection surface on a side opposite to the plate portion of the protection portion.

In the head unit, the plate portion may have a plurality of recording heads attached thereto while at least a part of the recording heads is provided at an interval.

According to another aspect of the invention, there is provided a recording apparatus including: the head unit.

In the recording apparatus, a moving portion which relatively moves the head unit and a recording medium may be provided, and the protection portion may be provided further on an upstream side than the recording head in a relative moving direction of at least the head unit and the recording medium.

In the recording apparatus, a transporting portion which intermittently transports the recording medium may be provided, and the moving portion may move the head unit in a direction which intersects with a transporting direction of the recording medium when the intermittent transporting is stopped.

In the recording apparatus, the moving portion may be the transporting portion which transports the recording medium with respect to the head unit, and the recording head may be a line head in which the nozzles are aligned in the direction which intersects with the transporting direction of the recording medium.

According to the invention, it is possible to prevent the mist which is generated as the liquid is discharged from the recording head from becoming adhered to the head unit.

### BRIEF DESCRIPTION OF THE DRAWINGS

The invention will be described with reference to the accompanying drawings, wherein like numbers reference like elements.

FIG. 1 is a schematic side view illustrating a recording apparatus of Example 1 of the invention.

FIG. 2 is a block diagram illustrating the recording apparatus of Example 1 of the invention.

FIG. 3 is a schematic perspective view illustrating a main portion of the recording apparatus of Example 1 of the invention.

FIG. 4 is a schematic bottom view illustrating the main portion of the recording apparatus of Example 1 of the invention.

FIG. 5 is a schematic front view illustrating the main portion of the recording apparatus of Example 1 of the invention.

FIG. 6 is a schematic bottom view illustrating a main portion of a recording apparatus of Example 2 of the invention.

### DESCRIPTION OF EXEMPLARY EMBODIMENTS

### EXAMPLE 1

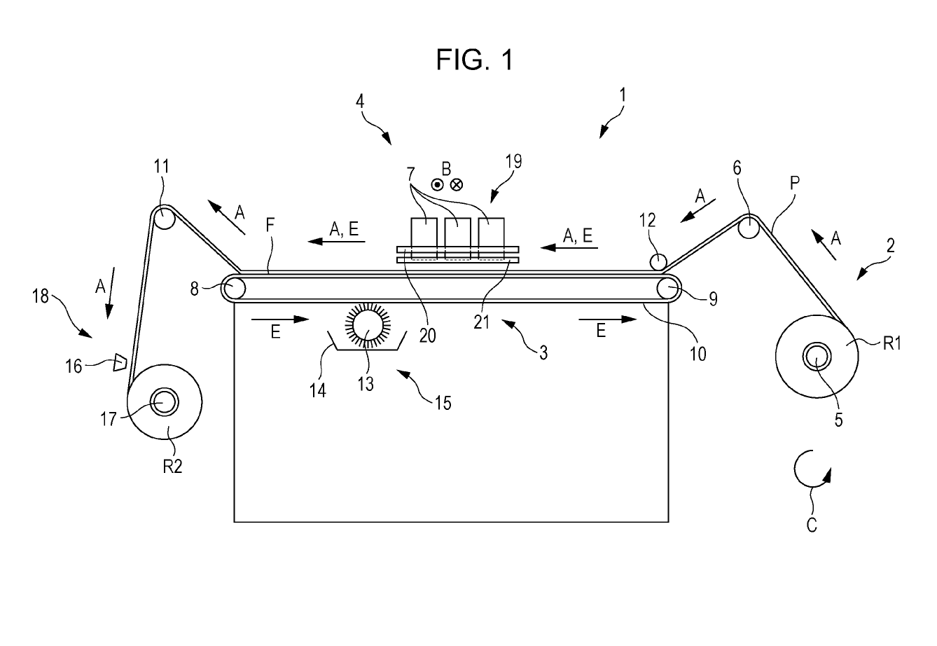

### FIGS. 1 to 5

Hereinafter, a recording apparatus according to examples of the invention will be described in detail with reference to the attached drawings.

First, an outline of a recording apparatus 1 according to Example 1 of the invention will be described.

FIG. 1 is a schematic side view of the recording apparatus 1 of the example.

The recording apparatus 1 of the example is provided with a feeding portion 2 which can feed a roll R1 of a recording medium P for performing the recording. In addition, a transporting mechanism 3 which functions as a transporting portion which transports the recording medium P in a transporting direction A by an adhesive belt 10 that supports the recording medium P on a supporting surface F to which an adhesive is adhered, is provided. In addition, a recording mechanism 4 which performs the recording by making a recording head 7 reciprocally scan in a reciprocating direction B that intersects with the transporting direction A of the recording medium P, is provided. In addition, a cleaning mechanism 15 of the adhesive belt 10 is provided. Furthermore, a winding axis 17 which winds the recording medium P, and a winding mechanism 18 having a cutter 16 that cuts out the wound recording medium P are provided.

The feeding portion 2 is provided with a rotation axis 5 that serves as a set position of the roll R1 of the recording medium P for performing the recording, and is configured to be capable of feeding the recording medium P to the transporting mechanism 3 via a driven roller 6 from the roll R1 set in the rotation axis 5. In addition, when feeding the recording medium P to the transporting mechanism 3, the rotation axis 5 rotates in a rotating direction C.

The transporting mechanism 3 includes the adhesive belt 10 which places and transports the recording medium P fed out of the feeding portion 2, a transporting roller 8 which functions as a driving roller that moves the adhesive belt 10, and a driven roller 9. The recording medium P is pressed to the supporting surface F of the adhesive belt 10 by a pressing roller 12, pasted, and placed. In addition, when transporting the recording medium P, the transporting roller 8 rotates in the rotating direction C, and the adhesive belt 10 moves in a direction E.

However, the transporting belt is not limited to the adhesive belt. For example, an electrostatic attraction type transporting belt may be used.

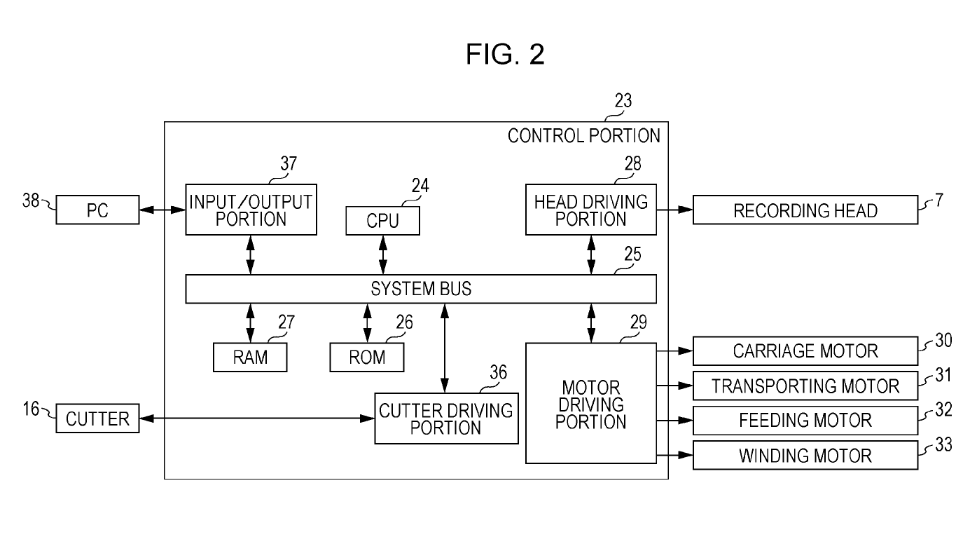

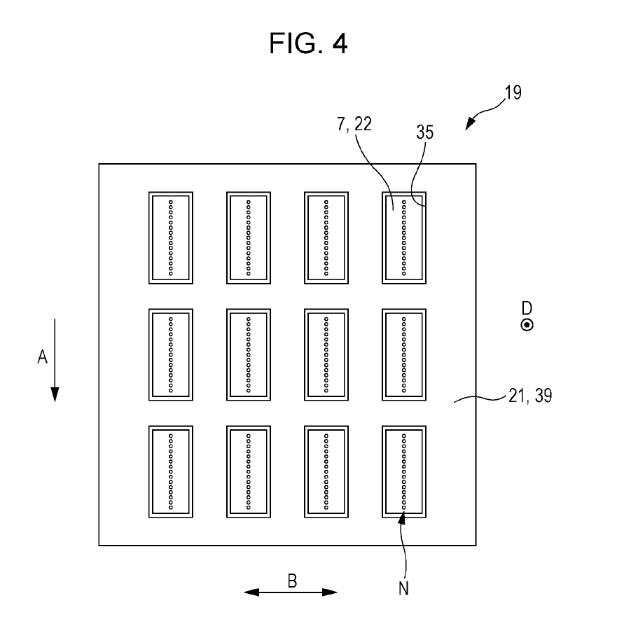

The recording mechanism 4 includes the recording head 7 which can discharge ink (liquid) from nozzles N (refer to FIG. 4), and a carriage motor 30 (refer to FIG. 2) which functions as a moving portion that makes a carriage 19 which functions as a head unit, on which the recording head 7 is loaded, reciprocate in the reciprocating direction B with respect to the recording medium P. In addition, the reciprocating direction B in FIG. 1 is a direction which is perpendicular to a paper surface.

When performing the recording, the recording is performed by making the recording head 7 reciprocally scan, but in the middle of recording and scanning (when the recording head 7 is moving), the transporting mechanism 3 stops the transporting of the recording medium P. In other words, when performing the recording, the reciprocating scanning of the recording head 7 and the transporting of the recording medium P are alternately performed. In other words, when performing the recording corresponding to the reciprocating scanning of the recording head 7, the transporting mechanism 3 intermittently transports (intermittently moves the adhesive belt 10) the recording medium P.

In addition, a specific configuration of the carriage 19 will be described later.

The cleaning mechanism 15 of the adhesive belt 10 includes a cleaning brush 13 in which a plurality of cleaning rollers are linked in a direction of a rotation axis, and a tray 14 in which detergent for cleaning the cleaning brush 13 is input.

The winding mechanism 18 is a mechanism which performs the recording and winds the recording medium P transported from the transporting mechanism 3 via a driven roller 11, and can perform the winding as a roll R2 of the recording medium P by setting a winding paper pipe or the like in the winding axis 17 and winding the recording medium P around this.

In addition, the recording apparatus 1 of the example is a recording apparatus which supports the rolled recording medium P by the adhesive belt 10 and transports the recording medium P, but the recording apparatus 1 is not limited to the recording apparatus having such a configuration. For example, the recording apparatus may be configured to be capable of nipping and transporting a cut-out type recording medium P other than the rolled recording medium P, by a pair or rollers which functions as a transporting portion.

Next, an electric configuration in the recording apparatus 1 of the example will be described.

FIG. 2 is a block diagram of the recording apparatus 1 of the example.

In a control portion 23, a CPU 24 which controls the entire recording apparatus 1 is provided. The CPU 24 is connected to a ROM 26 in which various control programs or the like that execute the CPU 24 are accommodated, and a RAM 27 which can temporarily accommodate data, via a system bus 25.

In addition, the CPU 24 is connected to a head driving portion 28 for driving the recording head 7 via the system bus 25.

In addition, the CPU 24 is connected to a motor driving portion 29 for driving the carriage motor 30, a transporting motor 31, a feeding motor 32, and a winding motor 33, via the system bus 25.

Here, the carriage motor 30 is a motor for moving the carriage 19 on which the recording head 7 is loaded. In addition, the transporting motor 31 is a motor for driving the transporting roller 8. In addition, the feeding motor 32 is a rotating mechanism of the rotation axis 5, and is a motor which drives the rotation axis 5 for sending out the recording medium P to the transporting mechanism 3. Additionally, the winding motor 33 is a driving motor for rotating the winding axis 17.

In addition, the CPU 24 is connected to a cutter driving portion 36 which drives the cutter 16 to cut out the recording medium P, via the system bus 25.

Furthermore, the CPU 24 is connected to an input/output portion 37 via the system bus 25, and the input/output portion 37 is connected to a PC 38 which inputs recording data or the like from an external device.

Next, a configuration of the carriage 19 which is a main portion of the recording apparatus 1 of the example will be described.

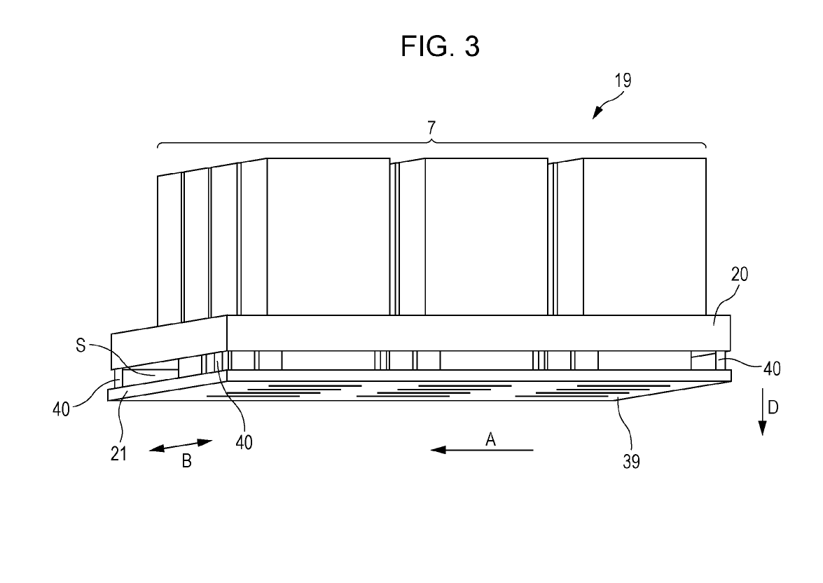

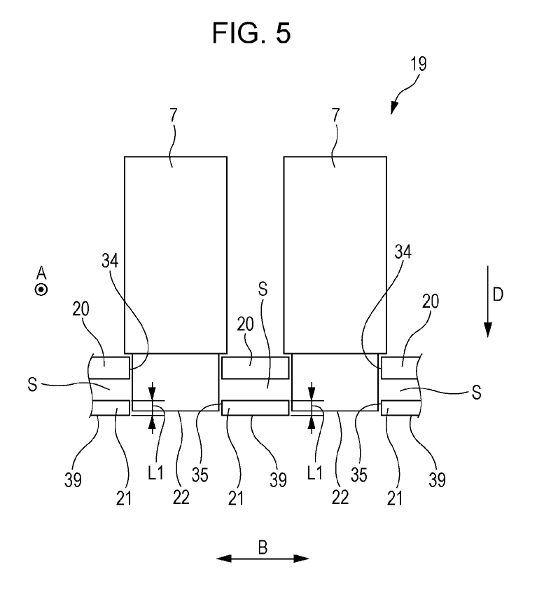

FIG. 3 is a schematic perspective view illustrating the carriage 19 of the example. In addition, FIG. 4 is a schematic bottom view illustrating the carriage 19 of the example. FIG. 5 is a schematic front view illustrating the carriage 19 of the example.

As illustrated in FIGS. 3 to 5, the carriage 19 of the example is provided with the recording head 7, a plate portion 20, and a protection portion 21.

In addition, as illustrated in FIG. 5, the plate portion 20 is configured to be capable of attaching the recording head 7 thereto in a state where a nozzle forming surface 22 on which the nozzles N (refer to FIG. 4) are formed in the recording head 7 protrudes to a lower side (adhesive belt 10 side) via a hole portion 34.

In addition, the protection portion 21 is for protecting the nozzle forming surface 22, and as illustrated in FIG. 3, when viewed from an intersecting direction which intersects with a protruding direction (direction which is toward the adhesive belt 10) D of the nozzle forming surface 22, the protection portion 21 is attached to the plate portion 20 by an attaching portion 40 in a state where a space S is provided between the protection portion 21 and the plate portion 20.

In addition, as illustrated in FIG. 5, when viewed from the intersecting direction, the nozzle forming surface 22 is positioned within a range of a thickness L1 in the protruding direction D of the protection portion 21 in a hole portion 35 of the protection portion 21.

In this configuration, it is possible to release the floating mist which is generated as the ink is discharged from the nozzle forming surface 22 of the recording head 7 via the space S, for example, according to the reciprocation of the carriage 19 in the reciprocating direction B. For this reason, the carriage 19 of the example is configured to be capable of preventing the mist from becoming adhered to the carriage 19. In other words, the recording apparatus 1 of the example is configured to be capable of performing the recording by preventing the mist from becoming adhered to the carriage 19.

Here, as illustrated in FIG. 5, the nozzle forming surface 22 is positioned in a state of being recessed with respect to a protection surface 39 on a side opposite to the plate portion 20 of the protection portion 21, not matching the protection surface 39 on a tip side (a side opposite to the plate portion 20) in the protruding direction D of the protection portion 21. In other words, the nozzle forming surface 22 is recessed with respect to the protection surface 39.

Because of such a configuration, even when an airflow which flows in the intersecting direction that intersects with the protruding direction D is generated between the nozzle forming surface 22 and the recording medium P, since the nozzle forming surface 22 is more recessed than the protection surface 39, the airflow does not influence the vicinity of the nozzle forming surface 22. Therefore, at the moment when the ink is discharged from the nozzle forming surface 22, it is possible to suppress a force in the direction which intersects with the discharging direction (corresponds to the protruding direction D) of the ink. In other words, even when the airflow which flows in the intersecting direction that intersects with the protruding direction D is generated, since the airflow has an influence after the force is applied in the discharging direction, it is possible to reduce the influence of the airflow. For this reason, the carriage 19 of the example is configured to be capable of preventing the generation of a shift in the discharging direction of the ink and the deterioration of recording quality.

In addition, as illustrated in FIGS. 3 to 5, a plurality (12) of recording heads 7 are attached to the plate portion 20 of the example at an interval.

For this reason, it is possible to release the floating mist via a part spaced at an interval, and to effectively prevent the mist from becoming adhered to the carriage 19.

In addition, the plurality of recording heads 7 are attached to the plate portion 20 of the example at an interval while the recording heads 7 are not in contact with each other. However, if the plurality of recording heads 7 are configured to be attached to the plate portion 20 while at least a part of the recording heads 7 the plate portion 20 is provided at an interval, it is possible to release the floating mist via the part spaced at an interval.

For this reason, even when the adjacent recording heads 7 are partially in contact with each other, the above-described effect can be achieved if there is the part spaced at an interval.

Here, as described above, the recording apparatus 1 of the example is provided with the transporting mechanism 3 which intermittently transports the recording medium P in the transporting direction A, and the carriage motor 30 which is a moving portion of the carriage 19 is configured to move the carriage 19 in the reciprocating direction B that intersects with the transporting direction A of the recording medium P when the intermittent transporting is stopped. In other words, the recording apparatus 1 of the example is a so-called serial type recording apparatus. For this reason, the serial type recording apparatus is configured to be capable of performing the recording by preventing the mist from becoming adhered to the carriage 19.

However, the invention is not limited to this configuration. For example, a recording apparatus which is configured to include a line head in which the nozzles N are aligned in the direction that intersects with the transporting direction A of the recording medium P, to use the head unit having a configuration (configuration in which the space S is provided) in which a positional relationship between the line head, the plate portion 20, and the protection portion 21 is similar to that of the carriage 19 of the example, and to transport (relatively move) the recording medium P with respect to the head unit by the transporting mechanism which functions as the moving portion.

In this configuration, it is possible to release the mist via the space S, and to perform the recording by preventing the mist from becoming adhered to the head unit in the recording apparatus configured to transport the recording medium P with respect to the line head.

The “line head” is a recording head in which a region of the nozzles N formed in the direction that intersects with the transporting direction A of the recording medium P is provided to be capable of covering the entire direction that intersects with the transporting direction A of the recording medium P, and which is used in the recording apparatus that forms the image by relatively moving the recording head or the recording medium P. In addition, the region of the nozzles N in the direction that intersects with the transporting direction A of the line head may be capable of covering the entire direction that intersects with the transporting direction A of all of the recording mediums P corresponding to the recording apparatus.

In addition, although not provided in the recording apparatus 1 of the example, an airflow generation portion, such as a fan, may be provided to be capable of releasing the mist via the space S more effectively, and the airflow may be generated in the space S.

### EXAMPLE 2

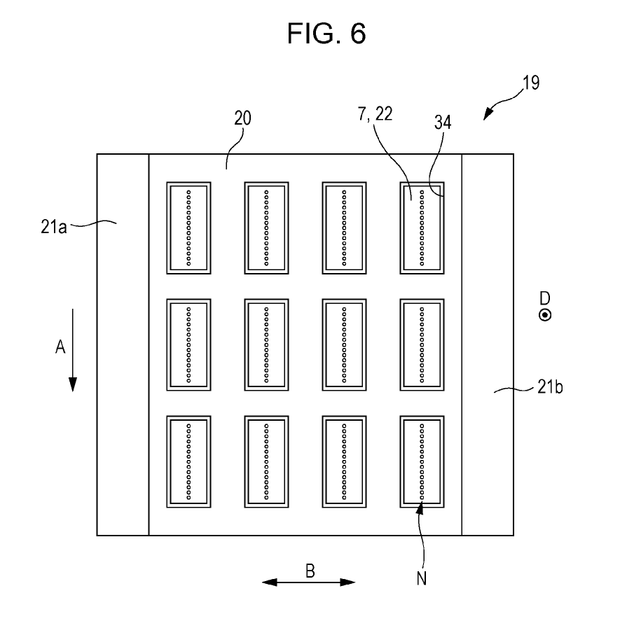

### FIG. 6

Next, a recording apparatus according to Example 2 of the invention will be described.

FIG. 6 is a schematic bottom view of the carriage 19 which is a main portion of the recording apparatus 1 of Example 2 of the invention, and is a view which corresponds to FIG. 4 illustrating the carriage 19 of Example 1. In addition, configuration members which are common to the above-described recording apparatus 1 are illustrated by the same reference numerals, and detailed description thereof will be omitted.

In the recording apparatus 1 of the example, only the configuration of the carriage 19 is different from that of the recording apparatus 1 of Example 1.

The protection portion 21 in the carriage 19 of Example 1 has a size equivalent to that of the plate portion 20 when viewed from a bottom surface.

Meanwhile, the carriage 19 of the example has a configuration in which protection portions 21a and 21b are attached to an end portion of the plate portion 20 in the reciprocating direction B of the carriage 19 in a state where the space S is provided, similar to the carriage 19 of Example 1.

In this manner, if the protection portion is provided further on an upstream side than the recording head 7 in the relative moving direction (reciprocating direction B) of at least the carriage 19 and the recording medium P, it is possible to generate the airflow which releases the floating mist via the space S on the upstream side in the relative moving direction as a regulating plate. Therefore, it is possible to perform the recording by effectively preventing the mist from becoming adhered to the carriage 19.

In addition, since the recording apparatus 1 of the example is configured to be capable of performing the recording by discharging the ink from the recording head 7 when moving both in the forward direction and the reverse direction of the reciprocating direction B, the protection portions are provided in both end portions of the plate portion 20 in the reciprocating direction B of the carriage 19. However, in a case where it is configured to be capable of performing the recording by discharging the ink from the recording head 7 when moving only in one direction of the reciprocating direction B, even when the protection portion is not provided on a downstream side in one direction, a role as a regulating plate can be achieved if the protection portion is provided on the upstream side in one direction.

In addition, the invention is not limited to the above-described example, various deformations are possible within the range of the invention described in the range of the patent claims, and it is needless to say that the deformations are also included in the range of the invention.

Above, the invention is described based on the specific examples. Here, the invention will be summarized again.

According to the first aspect of the invention, there is provided the head unit 19 including: the recording head 7 which can discharge the liquid from nozzles N; the plate portion 20 to which the recording head 7 is attached in a state where the nozzle forming surface 22 on which the nozzles N are formed protrudes; and the protection portion 21 which protects the nozzle forming surface 22, in which the protection portion 21 is attached to the plate portion 20 in a state where the space S is provided between the protection portion 21 and the plate portion 20 when viewed from the intersecting direction which intersects with the protruding direction D of the nozzle forming surface 22, and in which the nozzle forming surface 22 is positioned within a range of the thickness L1 in the protruding direction D of the protection portion 21 when viewed from the intersecting direction.

According the aspect, the protection portion 21 is attached to the plate portion 20 in a state where the space S is provided between the protection portion 21 and the plate portion 20 when viewed from the intersecting direction, and the nozzle forming surface 22 is positioned within the range of the thickness L1 in the protruding direction D of the protection portion 21 when viewed from the intersecting direction. In this configuration, it is possible to release the floating mist which is generated as the liquid is discharged from the nozzle forming surface 22 of the recording head 7 via the space S. For this reason, it is possible to prevent the mist from becoming adhered to the carriage 19.

According to the head unit 19 of the second aspect of the invention, in the first aspect, the nozzle forming surface 22 is positioned in a state of being recessed with respect to the protection surface 39 on the side opposite to the plate portion 20 of the protection portion 21.

According to the aspect, the nozzle forming surface 22 is positioned in a state of being recessed with respect to the protection surface 39 on the side opposite to the plate portion 20 of the protection portion 21. In other words, the nozzle forming surface 22 is recessed with respect to the protection surface 39. For this reason, even when the airflow which flows in the intersecting direction that intersects with the protruding direction D is generated between the nozzle forming surface 22 and the recording medium P, the airflow does not influence the vicinity of the nozzle forming surface 22. Therefore, at the moment when the liquid is discharged from the nozzle forming surface 22, it is possible to suppress a force in the direction which intersects with the discharging direction of the ink. In other words, even when the airflow which flows in the intersecting direction that intersects with the protruding direction D is generated, since the airflow has an influence after the force is applied in the discharging direction, it is possible to reduce the influence of the airflow. For this reason, it is possible to prevent the generation of a shift in the discharging direction of the ink and the deterioration of recording quality.

According to the head unit 19 of the third aspect of the invention, in the first or the second aspect, the plate portion 21 has the plurality of recording heads 7 attached thereto while at least a part of the recording heads 7 is provided at an interval S.

Here, the expression “the plurality of recording heads 7 attached thereto while at least a part of the recording heads 7 is provided at an interval” means that it is sufficient if there is a part spaced at an interval S, even when the adjacent recording heads 7 are partially in contact with each other.

According to the aspect, the protection portion 21 has the plurality of recording heads 7 attached thereto while at least a part of the recording heads 7 is provided at the interval S. For this reason, it is possible to release the floating mist via the part spaced at the interval S. For this reason, it is possible to effectively prevent the mist from becoming adhered to the carriage 19.

According to the fourth aspect of the invention, the recording apparatus 1 includes the head unit 19 according to any one of the first to the third aspects.

According to the aspect, it is possible to perform the recording by preventing the mist from becoming adhered to the carriage 19.

According to the fifth aspect of the invention, in the fourth aspect, the recording apparatus 1 includes the moving portion 30 which relatively moves the head unit 19 and the recording medium P, in which the protection portion 21 is provided further on the upstream side than the recording head 7 in the relative moving direction B of at least the head unit 19 and the recording medium P.

According to the aspect, the protection portion 21 is provided further on the upstream side than the recording head 7 in the relatively moving direction B of at least the head unit 19 and the recording medium P. For this reason, the protection portion 21 functions as the regulating plate, and it is possible to generate the airflow in which the floating mist is released via the space S on the upstream side of the relative moving direction B. Therefore, it is possible to perform the recording by effectively preventing the mist from becoming adhered to the carriage 19.

According to the sixth aspect of the invention, in the fifth aspect, the recording apparatus 1 includes the transporting portion 3 which intermittently transports the recording medium P, in which the moving portion 30 moves the head unit 19 in the direction which intersects with the transporting direction A of the recording medium P when the intermittent transporting is stopped.

According to the aspect, the transporting mechanism 3 which intermittently transports the recording medium is provided, and the carriage motor 30 moves the head unit 19 in the direction which intersects with the transporting direction A of the recording medium P when the intermittent transporting is stopped. In other words, the recording apparatus is a so-called serial type recording type. For this reason, in the serial type recording apparatus, it is possible to perform the recording by effectively preventing the mist from becoming adhered to the head unit 19.

According to the recording apparatus 1 of the seventh aspect of the invention, in the fifth aspect, the moving portion is the transporting portion which transports the recording medium P with respect to the head unit, and the recording head is a line head in which the nozzles N are aligned in the direction which intersects with the transporting direction of the recording medium P.

According to the aspect, the moving portion is the transporting portion which transports the recording medium P with respect to the head unit, and the recording head is a line head in which the nozzles N are aligned in the direction which intersects with the transporting direction of the recording medium P. For this reason, in the recording apparatus which is configured to transport the recording medium P with respect to the line head, it is possible to perform the recording by preventing the mist from becoming adhered to the head unit.

The entire disclosure of Japanese Patent Application No. 2015-012329, filed Jan. 26, 2015 is expressly incorporated by reference herein.

What is claimed is:

1. A head unit comprising:
a recording head which discharges liquid from nozzles;
a plate portion to which the recording head is attached in a state where a nozzle forming surface on which the nozzles are formed protrudes, on a surface which opposes a recording target medium of the recording head; and
a protection portion which protects the nozzle forming surface,
wherein the protection portion is attached to the plate portion in a state where a space is provided between the protection portion and the plate portion when viewed from an intersecting direction which intersects with a protruding direction of the nozzle forming surface, and
wherein the nozzle forming surface is positioned within a range of a thickness in the protruding direction of the protection portion when viewed from the intersecting direction.

2. The head unit according to claim 1,
wherein the nozzle forming surface is positioned in a state of being recessed with respect to a protection surface on a side opposite to the plate portion of the protection portion.

3. The head unit according to claim 1, further comprising:
a plurality of recording heads,
wherein the plate portion has the plurality of recording heads attached thereto while at least a part of the recording heads is provided at an interval.

4. A recording apparatus comprising:
the head unit according to claim 1.

5. A recording apparatus comprising:
the head unit according to claim 2.

6. A recording apparatus comprising:
the head unit according to claim 3.

7. The recording apparatus according to claim 4, further comprising:
a moving portion which relatively moves the head unit and a recording medium,
wherein the protection portion is provided further on an upstream side than the recording head in a relative moving direction of at least the head unit and the recording medium.

8. The recording apparatus according to claim 7, further comprising:
a transporting portion which intermittently transports the recording medium,
wherein the moving portion moves the head unit in a direction which intersects with a transporting direction of the recording medium when the intermittent transporting is stopped.

9. The recording apparatus according to claim 7,
wherein the moving portion is the transporting portion which transports the recording medium with respect to the head unit, and
wherein the recording head is a line head in which the nozzles are aligned in the direction which intersects with the transporting direction of the recording medium.
